(19) United States
(12) Patent Application Publication
(10) Pub. No.: US 2003/0013345 A1
(43) Pub. Date: Jan. 16, 2003

(54) ENGAGING STRUCTURE FOR ELECTRICAL WIRES OF A PLUG

(76) Inventor: Chun Chang Yen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/904,520

(22) Filed: Jul. 16, 2001

(51) Int. Cl. H01R 13/68

(52) U.S. Cl. 439/622

(57) ABSTRACT

This invention relates to an engaging structure for electrical wires of a plug. The improved plug provides with a pair of elastic inclined clips at an end of the connector. In assembly, the clips will clamp the wires or a cover around the wires elastically and when the wires is pulled outward, the clips may clamp the wires more firmly to prevent released or loosened from the plug.

### BACKGROUND OF INVENTION

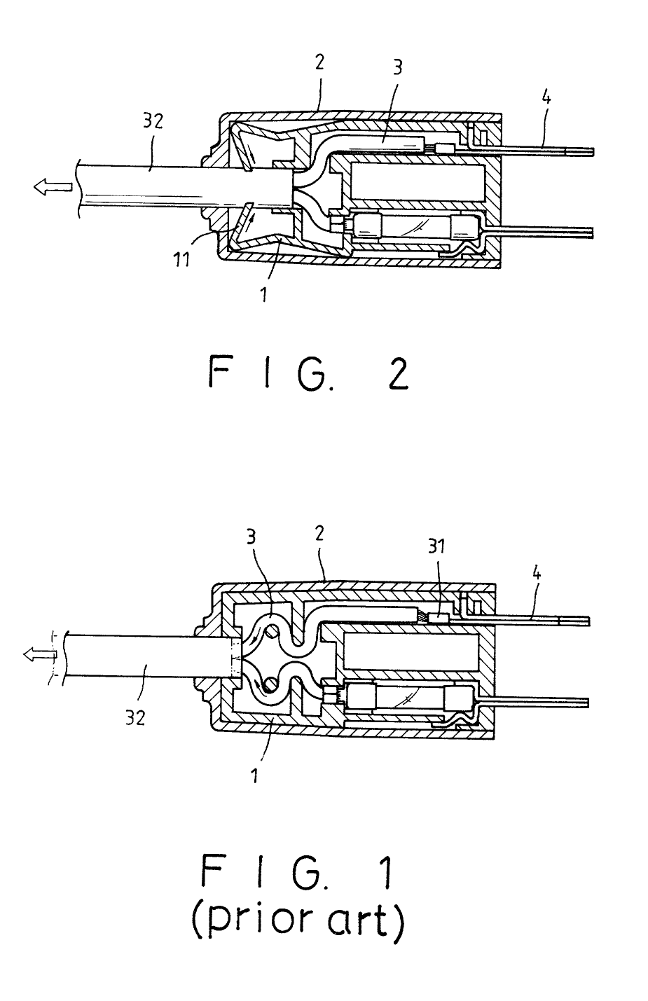

As shown in FIG. 1, it is known that a conventional plug includes an inner connector (1) and an outer shell (2). An electrical wire (3) connected with a pin (31) and a conductive slice (4) is received in the inner connector (1) and all of the above means are put inside the shell (2). An insulated cover (32) provided around the wire (3) is clipped by the connector (1) and the shell (2). Since this frictional engagement between the wire (3) and the connector (1) as well as the shell (2) is not strong enough, the wire (3) or the cover (32) may be loose when an accidental pulling is happened. Even the pin (31) is moved and the electrical connection will be inefficient.

Accordingly, the primary object of the invention is to provide a engaging structure for electrical wires of a plug, which provides an elastic clip at the end of the connector to engage the wires firmly for overcoming the drawback of a prior one and increasing utilized effect. Now the features and advantages of the invention will be described in detail with reference to the accompanying drawings.

### BRIEF DESCRIPTION OF THE INVENTION

FIG. 1 is a cross-sectional plan view showing a plug of a prior art structure.

FIG. 2 is a cross-sectional plan view showing a plug according to the present invention.

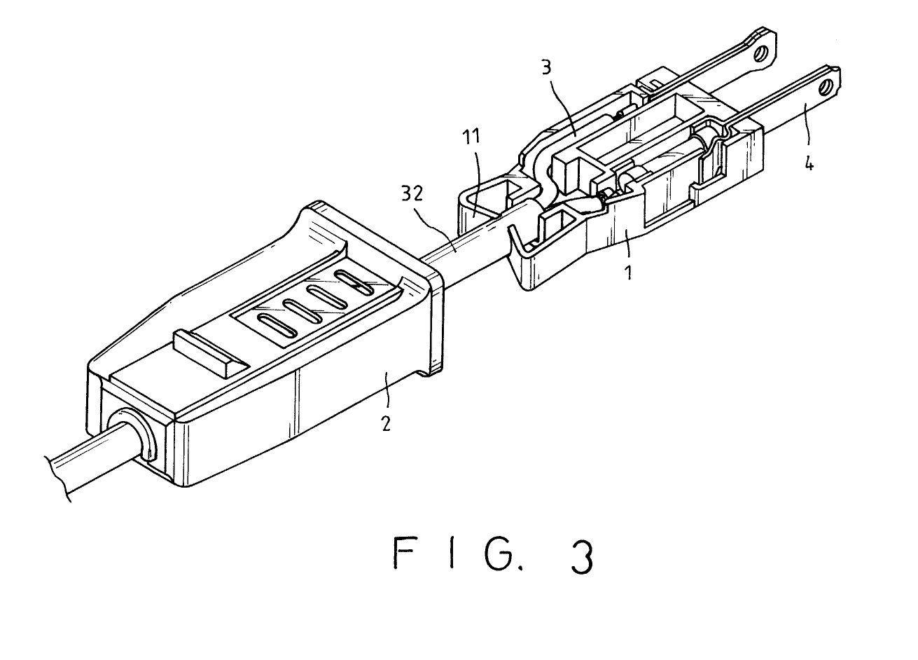

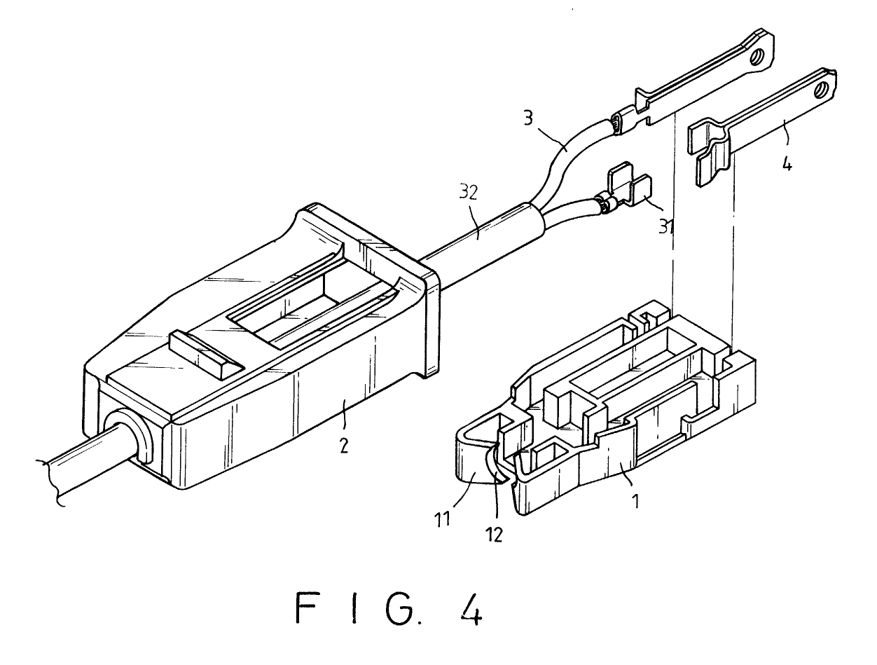

FIG. 3 is a perspective view showing a plug according to the present invention.

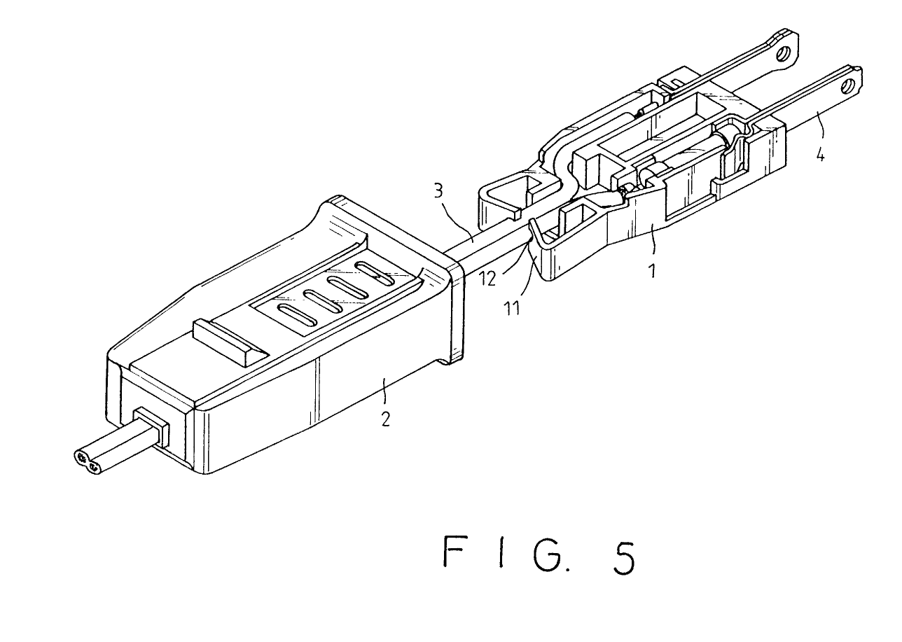

FIG. 4 is an exploded perspective view of FIG. 3 according to the present invention.

FIG. 5 is a perspective view showing another embodiment of a plug according to the present invention.

### DETAILED DESCRIPTION OF THE INVENTION

Please refer to FIGS. 2 to 4, the present invention includes an inner connector (1) provided with electrical wires (3) and conductive slices (4), all of which are received in an outer shell (2) to complete a plug as similar to a conventional one. The most characteristic of this invention is to provide a pair of elastic clips (11) at an end of the inner connector (1). The clip (11) is inward inclined and has provided with an arched groove (12) at end edge for clipping with wires (3) or the cover (31) in assembly.

Accordingly, if the wires (3) or the cover (31) is pulled outward, it will force the clips (11) to clamp the wires (3) or the cover (31) more firmly. It is to be understood that the increased clamping force may ensure the engagement between the wires and the plug that overcomes the drawback of a conventional plug.

As shown in FIG. 5, it shows another embodiment according to this invention. It changes the size of the arched groove (12) of the elastic clips (11) to fit with an electrical wire (3) without the cover (31) for providing the same secure clamping effect. Evidently it meets the requirements of granting a patent. We hereby file an application for a patent grant.

What is claimed is:

1. An engaging structure for electrical wires of a plug including an inner connector provided with electrical wires and conductive slices, all of which are received in an outer shell to complete a plug; the characteristic is to provide a pair of elastic clips at an end of the inner connector, which is inward inclined and has provided with an arched groove at end edge for clipping with wires or the cover in assembly, and that the wires or the cover is pulled outward will force the clips to clamp the wires or the cover more firmly to ensure the engagement between the wires and the plug.
